(19) United States
(12) Patent Application Publication
(10) Pub. No.: US 2025/0113259 A1
(43) Pub. Date: Apr. 3, 2025

(54) METHOD AND APPARATUS RELATED TO CONFIGURING USER EQUIPMENT FOR LOWER LAYER INTER-CELL MOBILITY

(71) Applicant: Nokia Technologies Oy, Espoo (FI)

(72) Inventors: Ahmad AWADA, Munich (DE); Srinivasan SELVAGANAPATHY, Bangalore (IN); Subramanya CHANDRASHEKAR, Bangalore (IN); Amaanat ALI, Espoo (FI); Panagiotis SPAPIS, Munich (DE); Halit Murat GÜRSU, Munich (DE)

(21) Appl. No.: 18/725,375

(22) PCT Filed: Dec. 19, 2022
(86) PCT No.: PCT/EP2022/086642

§ 371 Date: Jun. 28, 2024

(30) Foreign Application Priority Data
Jan. 6, 2022 (IN) 202241000753

(51) Int. Cl. H04W 36/00; H04B 7/06; H04L 5/00; H04W 24/10

(52) U.S. Cl. CPC H04W 36/0058; H04B 7/0626; H04L 5/0051; H04W 24/10

(57) ABSTRACT

A technique, comprising: generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

### TECHNICAL FIELD

The present disclosure relates to apparatus, a method, and a computer program, and in particular, but not exclusively to apparatus, methods and computer programs related to configuring user equipment for lower layer inter-cell mobility.

### BACKGROUND

Some communication systems use a cellular radio access network in which base station functionality for a cell is split between at least a distributed unit and a central unit.

According to a lower layer inter-cell mobility procedure, a decision to switch a user equipment from one cell to another may be made by a distributed unit operating the serving cell for the user equipment.

### SUMMARY

A method, comprising: generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

The information set may further comprise information for configuring the user equipment for reporting results of the measurements via the first cell, for making the mobility decision at the first distributed unit.

The information set may further comprise information for configuring the user equipment for operation in the second cell in the event of a decision at the first distributed unit to command the user equipment to perform serving cell change to the second cell.

Generating the information set may be based at least partly on information received via signalling associated with the user equipment.

Generating the information set may be based at least partly on information received via signalling not associated with the user equipment.

Generating the information set may be performed at the first distributed unit; and the method may comprise: receiving at the first distributed unit at least second cell measurement resource information regarding measurement resources for the second cell; and sending the generated information set to a central unit associated with the first distributed unit, for forwarding by the central unit to the user equipment.

Operation of the second cell may comprise making at least two types of reference signal transmissions, and the method may comprise: receiving at the first distributed unit an indicator of the type of reference signal transmission for the measurement resources for the second cell.

Generating the information set may be performed at a central unit associated with the first distributed unit; and the method may comprise: receiving at the central unit at least: second cell measurement resource information regarding measurement resources for the second cell; first cell measurement resource information regarding measurement resources for the first cell; and measurement reporting information about reporting measurement results to the first distributed unit via the first cell; and sending the generated information set to the user equipment.

Operation of the first cell may comprise making at least two types of reference signal transmissions, and the method may comprise: receiving at the central unit an indicator of the type of reference signal transmission for the measurement resources for the first cell; and sending to the second distributed unit a request for information about measurement resources for the same type of reference signal transmission in the second cell.

The method may further comprise: receiving at the central unit: information about measurement resources for the same type of reference signal transmission in the second cell, in the event that operation of the second cell comprises making the same type of reference signal transmission; or information about measurement resources for another type of reference signal transmission in the second cell, in the event that operation of the second cell does not comprise making the same type of reference signal transmission; and sending to the first distributed unit an indication of the type of reference signal transmission for which information about measurement resources was received from the second distributed unit.

Generating the information set may be performed at the second distributed unit; and the method may comprise: receiving at the second distributed unit at least: first cell measurement resource information regarding measurement resources for the first cell; and measurement reporting information about reporting measurement results to the first distributed unit via the first cell; and sending the generated information set to a central unit associated with the first distributed unit, for forwarding by the central unit to the user equipment.

The method may further comprise: sending, to the central unit for forwarding to the first distributed unit, at least one of the second cell measurement resource information regarding measurement resources for the second cell and information regarding transmission configuration indicator states for the second cell.

Operation of the first cell may comprise making at least two types of reference signal transmissions, and the method may comprise: receiving at the second distributed unit an indicator of the type of reference signal transmission for the measurement resources for the first cell; and including in the information set information about measurement resources for the same type of reference signal transmission in the second cell, in the event that operation of the second cell comprises making the same type of reference signal transmission; or including in the information set information about measurement resources for another type of reference signal in the second cell, in the event that operation of the second cell does not comprise making the same type of reference signal transmission.

A method, comprising: receiving an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; performing measurements for at least the first and second cells according to the information set; reporting results of the measurements to the first distributed unit via the serving cell, for the mobility decision at the first distributed unit.

A method, comprising: sending to a unit of a radio access network an indicator indicating a type of reference signal transmission for which the unit of the radio access network is to provide information about resources for measurements for a mobility decision at a distributed unit of the radio access network.

A method comprising: receiving at a unit of a radio access network an indicator indicating a type of reference signal transmission for which the unit of the radio access network is to provide information about resources for measurements for a mobility decision at a distributed unit of the radio access network.

A method, comprising: receiving measurement resource information regarding measurement resources for at least one cell, wherein the measurement resource information identifies measurement resources mappable to a user equipment according to at least one parameter of the user equipment.

The at least one parameter may comprise capability of the user equipment.

Apparatus, comprising: means for generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

The information set may further comprise information for configuring the user equipment for reporting results of the measurements via the first cell, for making the mobility decision at the first distributed unit.

The information set may further comprise information for configuring the user equipment for operation in the second cell in the event of a decision at the first distributed unit to command the user equipment to perform serving cell change to the second cell.

The means for generating may comprise means for generating the information set based at least partly on information received via signalling associated with the user equipment.

The means for generating may comprise means for generating the information set based at least partly on information received via signalling not associated with the user equipment.

The apparatus may be the first distributed unit; and the apparatus may comprise: means for receiving at least second cell measurement resource information regarding measurement resources for the second cell; and means for sending the generated information set to a central unit associated with the first distributed unit, for forwarding by the central unit to the user equipment.

Operation of the second cell may comprise making at least two types of reference signal transmissions, and the apparatus may comprise: means for receiving an indicator of the type of reference signal transmission for the measurement resources for the second cell.

The apparatus may be a central unit associated with the first distributed unit; and the apparatus may comprise: means for receiving at least: second cell measurement resource information regarding measurement resources for the second cell; first cell measurement resource information regarding measurement resources for the first cell; and measurement reporting information about reporting measurement results to the first distributed unit via the first cell; and means for sending the generated information set to the user equipment.

Operation of the first cell may comprise making at least two types of reference signal transmission, and the apparatus may comprise: means for receiving an indicator of the type of reference signal transmission for the measurement resources for the first cell; and means for sending to the second distributed unit a request for information about measurement resources for the same type of reference signal transmission in the second cell.

The apparatus may further comprise: means for receiving: information about measurement resources for the same type of reference signal transmission in the second cell, in the event that operation of the second cell comprises making the same type of reference signal transmission; or information about measurement resources for another type of reference signal transmission in the second cell, in the event that operation of the second cell does not comprise making the same type of reference signal transmission; and means for sending to the first distributed unit an indication of the type of reference signal transmission for which information about measurement resources was received from the second distributed unit.

The apparatus may be the second distributed unit; and the apparatus may comprise: means for receiving at least: first cell measurement resource information regarding measurement resources for the first cell; and measurement reporting information about reporting measurement results to the first distributed unit via the first cell; and means for sending the generated information set to a central unit associated with the first distributed unit, for forwarding by the central unit to the user equipment.

The apparatus may further comprise: means for sending, to the central unit for forwarding to the first distributed unit, at least one of the second cell measurement resource information regarding measurement resources for the second cell and information regarding transmission configuration indicator states for the second cell.

Operation of the first cell may comprise making at least two types of reference signal transmissions, and the apparatus may comprise: means for receiving an indicator of the type of reference signal transmission for the measurement resources for the first cell; and means for: including in the information set information about measurement resources for the same type of reference signal transmission in the second cell, in the event that operation of the second cell comprises making the same type of reference signal transmission; or including in the information set information about measurement resources for another type of reference signal in the second cell, in the event that operation of the second cell does not comprise making the same type of reference signal transmission.

Apparatus, comprising: means for receiving an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; means for performing measurements for at least the first and second cells according to the information set; means for reporting results of the measurements to the first distributed unit via the serving cell, for the mobility decision at the first distributed unit.

Apparatus, comprising: means for sending to a unit of a radio access network an indicator indicating a type of reference signal transmission for which the unit of the radio access network is to provide information about resources for measurements for a mobility decision at a distributed unit of the radio access network.

Apparatus comprising: means for receiving at a unit of a radio access network an indicator indicating a type of reference signal transmission for which the unit of the radio access network is to provide information about resources for measurements for a mobility decision at a distributed unit of the radio access network.

Apparatus, comprising: means for receiving measurement resource information regarding measurement resources for at least one cell, wherein the measurement resource information identifies measurement resources mappable to a user equipment according to at least one parameter of the user equipment.

The at least one parameter may comprise capability of the user equipment.

Apparatus comprising: at least one processor; and at least one memory including computer program code, the at least one memory and computer program code configured to, with the at least one processor, cause the apparatus to perform: generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

The information set may further comprise information for configuring the user equipment for reporting results of the measurements via the first cell, for making the mobility decision at the first distributed unit.

The information set may further comprise information for configuring the user equipment for operation in the second cell in the event of a decision at the first distributed unit to command the user equipment to perform serving cell change to the second cell.

Generating the information set may be based at least partly on information received via signalling associated with the user equipment.

Generating the information set may be based at least partly on information received via signalling not associated with the user equipment.

The apparatus may be the first distributed unit; and the at least one memory and computer program code may be configured to, with the at least one processor, cause the apparatus to: receive at least second cell measurement resource information regarding measurement resources for the second cell; and send the generated information set to a central unit associated with the first distributed unit, for forwarding by the central unit to the user equipment.

Operation of the second cell may comprise making at least two types of reference signal transmissions, and the at least one memory and computer program code are configured to, with the at least one processor, cause the apparatus to: receive an indicator of the type of reference signal transmission for the measurement resources for the second cell.

The apparatus may be a central unit associated with the first distributed unit; and the at least one memory and computer program code may be configured to, with the at least one processor, cause the apparatus to: receive at least: second cell measurement resource information regarding measurement resources for the second cell; first cell measurement resource information regarding measurement resources for the first cell; and measurement reporting information about reporting measurement results to the first distributed unit via the first cell; and send the generated information set to the user equipment.

Operation of the first cell may comprise making at least two types of reference signal transmissions, and the at least one memory and computer program code may be configured to, with the at least one processor, cause the apparatus to: receive an indicator of the type of reference signal transmission for the measurement resources for the first cell; and send to the second distributed unit a request for information about measurement resources for the same type of reference signal transmission in the second cell.

The at least one memory and computer program code may be configured to, with the at least one processor, cause the apparatus to: receive: information about measurement resources for the same type of reference signal transmission in the second cell, in the event that operation of the second cell comprises making the same type of reference signal transmission; or information about measurement resources for another type of reference signal transmission in the second cell, in the event that operation of the second cell does not comprise making the same type of reference signal transmission; and send to the first distributed unit an indication of the type of reference signal transmission for which information about measurement resources was received from the second distributed unit.

The apparatus may be the second distributed unit; and the at least one memory and computer program code may be configured to, with the at least one processor, cause the apparatus to: receive at least: first cell measurement resource information regarding measurement resources for the first cell; and measurement reporting information about reporting measurement results to the first distributed unit via the first cell; and send the generated information set to a central unit associated with the first distributed unit, for forwarding by the central unit to the user equipment.

The at least one memory and computer program code may be configured to, with the at least one processor, cause the apparatus to: send, to the central unit for forwarding to the first distributed unit, at least one of the second cell measurement resource information regarding measurement resources for the second cell and information regarding transmission configuration indicator states for the second cell.

Operation of the first cell may comprise making at least two types of reference signal transmissions, and the at least one memory and computer program code may be configured to, with the at least one processor, cause the apparatus to: receive an indicator of the type of reference signal transmission for the measurement resources for the first cell; and include in the information set information about measurement resources for the same type of reference signal transmission in the second cell, in the event that operation of the second cell comprises making the same type of reference signal transmission; or include in the information set information about measurement resources for another type of reference signal in the second cell, in the event that operation of the second cell does not comprise making the same type of reference signal transmission.

Apparatus comprising: at least one processor; and at least one memory including computer program code, the at least one memory and computer program code configured to, with the at least one processor, cause the apparatus to perform: receiving an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; performing measurements for at least the first and second cells according to the information set; and reporting results of the measurements to the first distributed unit via the serving cell, for the mobility decision at the first distributed unit.

Apparatus comprising: at least one processor; and at least one memory including computer program code, the at least one memory and computer program code configured to, with the at least one processor, cause the apparatus to perform: sending to a unit of a radio access network an indicator indicating a type of reference signal transmission for which the unit of the radio access network is to provide information about resources for measurements for a mobility decision at a distributed unit of the radio access network.

Apparatus comprising: at least one processor; and at least one memory including computer program code, the at least one memory and computer program code configured to, with the at least one processor, cause the apparatus to perform: receiving at a unit of a radio access network an indicator indicating a type of reference signal transmission for which the unit of the radio access network is to provide information about resources for measurements for a mobility decision at a distributed unit of the radio access network.

Apparatus comprising: at least one processor; and at least one memory including computer program code, the at least one memory and computer program code configured to, with the at least one processor, cause the apparatus to perform: receiving measurement resource information regarding measurement resources for at least one cell, wherein the measurement resource information identifies measurement resources mappable to a user equipment according to at least one parameter of the user equipment.

The at least one parameter may comprise capability of the user equipment.

Apparatus, comprising: generating circuitry for generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

Apparatus, comprising: receiving circuitry for receiving an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; performing circuitry for performing measurements for at least the first and second cells according to the information set; reporting circuitry for reporting results of the measurements to the first distributed unit via the serving cell, for the mobility decision at the first distributed unit.

Apparatus, comprising: sending circuitry for sending to a unit of a radio access network an indicator indicating a type of reference signal transmission for which the unit of the radio access network is to provide information about resources for measurements for a mobility decision at a distributed unit of the radio access network.

Apparatus comprising: receiving circuitry for receiving at a unit of a radio access network an indicator indicating a type of reference signal transmission for which the unit of the radio access network is to provide information about resources for measurements for a mobility decision at a distributed unit of the radio access network.

Apparatus, comprising: receiving circuitry for receiving measurement resource information regarding measurement resources for at least one cell, wherein the measurement resource information identifies measurement resources mappable to a user equipment according to at least one parameter of the user equipment.

A computer readable medium comprising program instructions stored thereon for performing: generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

A computer readable medium comprising program instructions stored thereon for performing: receiving an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; performing measurements for at least the first and second cells according to the information set; reporting results of the measurements to the first distributed unit via the serving cell, for the mobility decision at the first distributed unit.

A computer readable medium comprising program instructions stored thereon for performing: sending to a unit of a radio access network an indicator indicating a type of reference signal transmission for which the unit of the radio access network is to provide information about resources for measurements for a mobility decision at a distributed unit of the radio access network.

A computer readable medium comprising program instructions stored thereon for performing: receiving at a unit of a radio access network an indicator indicating a type of reference signal transmission for which the unit of the radio access network is to provide information about resources for measurements for a mobility decision at a distributed unit of the radio access network.

A computer readable medium comprising program instructions stored thereon for performing: receiving measurement resource information regarding measurement resources for at least one cell, wherein the measurement resource information identifies measurement resources mappable to a user equipment according to at least one parameter of the user equipment.

A non-transitory computer readable medium comprising program instructions stored thereon for performing: generating an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

A non-transitory computer readable medium comprising program instructions stored thereon for performing: receiving an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; performing measurements for at least the first and second cells according to the information set; reporting results of the measurements to the first distributed unit via the serving cell, for the mobility decision at the first distributed unit.

A non-transitory computer readable medium comprising program instructions stored thereon for performing: sending to a unit of a radio access network an indicator indicating a type of reference signal transmission for which the unit of the radio access network is to provide information about resources for measurements for a mobility decision at a distributed unit of the radio access network.

A non-transitory computer readable medium comprising program instructions stored thereon for performing: receiving at a unit of a radio access network an indicator indicating a type of reference signal transmission for which the unit of the radio access network is to provide information about resources for measurements for a mobility decision at a distributed unit of the radio access network.

A non-transitory computer readable medium comprising program instructions stored thereon for performing: receiving measurement resource information regarding measurement resources for at least one cell, wherein the measurement resource information identifies measurement resources mappable to a user equipment according to at least one parameter of the user equipment.

A computer program comprising computer executable code which when run on at least one processor is configured to cause an apparatus at least to: generate an information set for a user equipment; wherein the information set at least includes information for configuring the user equipment for performing measurements for a mobility decision at a first distributed unit operating a first, serving cell of a radio access network; wherein the measurements comprise at least: measurements for the first, serving cell, and measurements for a second cell operated by a second distributed unit of the radio access network.

A computer program comprising computer executable code which when run on at least one processor is configured to cause an apparatus at least to: receive an information set via a first, serving cell operated by a first distributed unit of a radio access network; wherein the information set at least includes information about performing measurements for a mobility decision at the first distributed unit; wherein the measurements comprise at least: measurements for the first, serving cell, and measurements for a second cell operated by a second distributed unit of the radio access network; perform measurements for at least the first and second cells according to the information set; report results of the measurements to the first distributed unit via the serving cell, for the mobility decision at the first distributed unit.

A computer program comprising computer executable code which when run on at least one processor is configured to cause an apparatus at least to: send to a unit of a radio access network an indicator indicating a type of reference signal transmission for which the unit of the radio access network is to provide information about resources for measurements for a mobility decision at a distributed unit of the radio access network.

A computer program comprising computer executable code which when run on at least one processor is configured to cause an apparatus at least to: receive at a unit of a radio access network an indicator indicating a type of reference signal transmission for which the unit of the radio access network is to provide information about resources for measurements for a mobility decision at a distributed unit of the radio access network.

A computer program comprising computer executable code which when run on at least one processor is configured to cause an apparatus at least to: receive measurement resource information regarding measurement resources for at least one cell, wherein the measurement resource information identifies measurement resources mappable to a user equipment according to at least one parameter of the user equipment.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows an example system to which embodiments may be applied;

FIG. 2 shows a representation of an example of operations at a user equipment and units of a radio access network according to an example embodiment;

FIG. 3 shows a representation of another example of operations at a user equipment and units of a radio access network according to another example embodiment;

FIG. 4 shows a representation of another example of operations at a user equipment and units of a radio access network according to another example embodiment;

FIG. 5 shows a representation of another example of operations at a user equipment and units of a radio access network according to another example embodiment;

FIG. 6 shows a representation of another example of operations at a user equipment and units of a radio access network according to another example embodiment;

FIG. 7 shows a representation of another example of operations at a user equipment and units of a radio access network according to another example embodiment;

FIG. 8 shows a representation of an example of apparatus for implementing operations at a gNB-CU or gNB-DU according to some example embodiments; and

FIG. 9 shows a representation of an example of apparatus for implementing operations at a gNB-RU or UE according to some example embodiments;

FIG. 10 shows a representation of an example of non-volatile memory media; and

FIG. 11 shows a representation of an example of an information element used in example embodiments.

### DETAILED DESCRIPTION

By way of example, the following description focusses on the example of user equipment (UE) and a radio access network (RAN) operating according to 3GPP 5G technology, but the underlying technique is also applicable to user equipment and radio access networks operating according to other technologies, such as more evolved 3GPP technology.

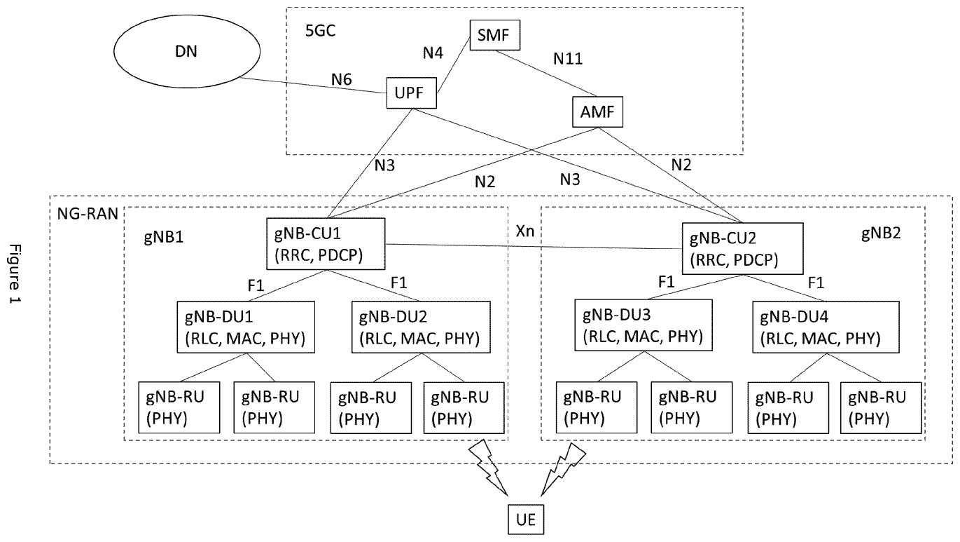

FIG. 1 shows a representation of one example of a simplified 3GPP 5G system architecture showing elements and functional entities relevant to the description of example embodiments below. All the units shown in FIG. 1 are logical units. The connections shown in FIG. 1 are logical connections; the actual physical connections may be different. It is apparent to a person skilled in the art that a 5G system may comprise also other functions and structures than those shown in FIG. 1. FIG. 1 shows only one instance of each core network function shown, but a 5G core network may comprise multiple instances of one or more core network functions at different geographical locations. One or more units shown in FIG. 1 may be split into multiple units. For example, each gNB central unit (gNB-CU) may be divided into core plane (CP) and user plane (UP) units.

Embodiments of the invention are not, however, restricted to the system given as an example in FIG. 1, but a person skilled in the art may apply the solution to other communication systems provided with necessary properties.

The functionality of a NG-RAN gNB (5G base station) is split into a central unit (gNB-CU), a plurality of distributed units (gNB-DU) associated with the gNB-CU, and one or more radio units (gNB-RU) associated with each gNB-DU. A gNB-RU provides the digital front end (DFE), parts of the PHY layer functionality, and digital beamforming functionality. A gNB-DU provides Layer 1/2 (L1/2) functionality, including MAC (Medium Access Control) functionality, RLC (Radio Link Control) functionality, and part of the PHY layer functionality. A gNB-CU provides higher layer functionality including Layer 3 (L3) functionality—RRC (Radio Resource Control) functionality and PDCP (Packet Data Convergence Protocol) functionality.

Each gNB-CU is connected to a core network user plane function (UPF), for routing and forwarding user data packets and for providing connectivity of devices to one or more external packet data networks (DN), and to an access mobility management function (AMF) for controlling access and mobility of user equipments.

The term “user equipment” (UE) here refers to any device, apparatus or component implementing at least 3GPP user equipment (UE) functionality.

The UE may be a mobile or static device (e.g. a portable or non-portable computing device) including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a UE device may also be a nearly exclusive uplink only device, of which an example is a camera or video camera loading images or video clips to a network. A UE device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a UE device may comprise a user portable device with radio parts (such as a watch, earphones or eyeglasses) and the computation is carried out in the cloud. 5G enables using multiple input—multiple output (MIMO) antennas, and may involve large numbers of base stations (gNBs) including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G may employ multiple radio interfaces, e.g. below 6 GHz or above 24 GHz, cmWave and mmWave, and may also be integrable with existing legacy radio access technologies, such as LTE. Integration with LTE may be implemented, as a system, where macro coverage is provided by LTE and 5G radio interface access comes from small cells by aggregation to the LTE. In other words, 5G may support both inter-RAT operability (such as LTE-5G) and inter-RI operability (inter-radio interface operability, such as below 6 GHz—cmWave, 6 or above 24 GHz—cmWave and mmWave). 5G networks may employ network slicing, in which multiple independent and dedicated virtual sub-networks (network instances) may be created within the same infrastructure to run services that have different requirements on latency, reliability, throughput and mobility.

Low latency applications and services may be facilitated by bringing content close to the 5G system, which leads to local break out and multi-access edge computing (MEC). 5G enables analytics and knowledge generation to occur at the source of the data. This approach may involve leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

For simplicity of explanation, the examples described below are examples in which a single cell is identified as a target cell for L1/2 intercell mobility. However, there may be more than one target cell. For example, a plurality of target cells may comprise cells operated by a plurality of distributed units. For example, there may be one or more target cells operated by one or more DUs other than the DU operating the serving cell, and there may additionally be one or more target cells operated by the DU operating the serving cell.

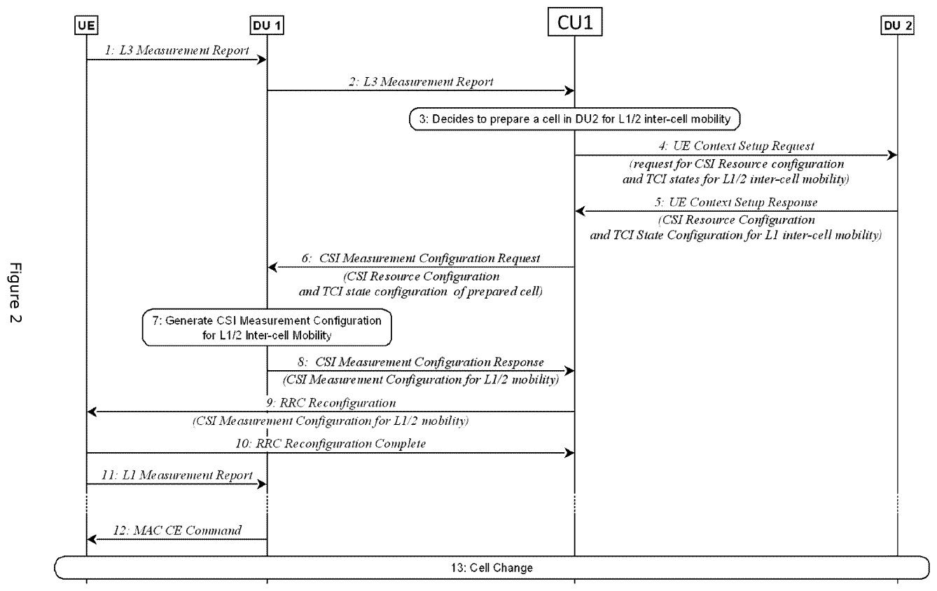

FIG. 2 shows a representation of an example of operations at UE and units of a radio access network of FIG. 1 according to an example embodiment.

UE is served by a serving cell operated by gNB-DU1. UE transmits a L3 measurement report via the serving cell (OPERATION 1 of FIG. 2). DU1 forwards the L3 measurement report to the gNB-CU1 associated with DU1 (OPERATION 2 of FIG. 2). Based on the L3 measurement report, CU1 decides to prepare a cell operated by another distributed unit gNB-DU2 for L1/2 inter-cell mobility (OPERATION 3 in FIG. 2). CU1 sends to DU2 a request (e.g. a UE Context Setup message) for information about resources for L1/2 mobility measurements in the target cell (e.g. CSI (Channel State Information) Resource Configuration), and information about UE operation in the target cell in the event of a L1/2 handover to the target cell (e.g. TCI state information) (OPERATION 4 of FIG. 2). DU2 sends the requested information to CU1 (e.g. in a UE Context Setup Response message) (OPERATION 5 of FIG. 2). CU1 sends to serving DU1 the information received from DU2 (e.g. in a CSI Measurement Configuration Request message (OPERATION 6 of FIG. 2). Serving DU1 generates (OPERATION 7 of FIG. 2) an information element (e.g. CSI Measurement Configuration for L1/2 inter-cell mobility) for sending to UE (OPERATION 7 of FIG. 2). FIG. 11 shows a representation of an example information element. The information element (IE) includes (a) the information received from DU2 via CU1 about L1/2 mobility measurement resources in the target cell (e.g. CSI Resource Configuration for the target cell) and about operation in the target cell in the event of a L1/2 handover to the target cell (e.g. TCI (Transmission Configuration Indicator) state information for the target cell); (b) information about L1/2 mobility measurement resources (CSI resource configuration) in the serving cell; and (c) information about reporting L1/2 mobility measurement results via the serving cell to DU1 (e.g. CSI reporting configuration). DU1 sends the information element to CU1 (e.g. in CSI Measurement Configuration Response message) (OPERATION 8 of FIG. 2). CU1 sends via DU1 and the serving cell the information element to UE (e.g. in a L3 RRC Reconfiguration message) (OPERATION 9 of FIG. 2). UE adopts the configuration indicated by the information element received from CU1, and informs CU1 via the serving cell and DU1 of completion of the UE reconfiguration (e.g. sends a RRC Reconfiguration Complete message to CU1) (OPERATION 10 of FIG. 2). UE makes measurements according to the configuration indicated in the information element received from CU1, and reports the measurement results to DU1 via the serving cell (OPERATION 11 of FIG. 2). Based on the measurement results, DU1 may send a L1/2 command (e.g. MAC CE Command) to UE (OPERATION 12 of FIG. 2) triggering UE to change to the target cell operated by DU2 (OPERATION 13 of FIG. 2).

In the example shown in FIG. 2, non-serving DU2 provides the L1/2 mobility information to CU1 as part of UE associated signaling. Non-serving DU2 sends the L1/2 intercell mobility information to CU1 during the preparation of the UE context at the candidate target cell (e.g. in a UE Context Setup Response message).

According to another example, non-serving DU2 provides the L1/2 intercell mobility information to CU1 as part of non-UE associated signaling (i.e. before CU1 receives the L3 measurement report for UE). For example, non-serving DU2 may include the L1/2 intercell mobility information in a message (such as e.g. a F1 Setup Request message of the kind described at 3GPP TS 38.473, section 8.2.3.2, or a gNB-DU Configuration Update message of the kind described at TS 38.473, section 8.2.4.2) during the setup of the F1 interface between CU1 and DU2, or as part of a DU configuration update procedure for DU2. One or more common sets of L1/2 mobility information (e.g. CSI resource configuration(s) and TCI states) may be applicable for UEs configured with L1/L2 mobility. A plurality of sets may be mapped to respective levels of UE capability. CU1 may choose one of the sets for a specific UE based on information at CU1 about the capability of the specific UE.

According to one example, operations 6 to 8 of FIG. 2 are performed while setting up the UE context for a prepared candidate cell in DU1 controlling the serving cell.

According to another example, operations 6 and 8 of FIG. 2 are performed using a UE context modification procedure. For example, operations 6 and 8 of FIG. 2 may be performed using UE Context Modification Request and UE Context Modification Response messages of the kind described in 3GPP TS 38.473.

In order to reduce the complexity of making both serving cell and target cell measurements at the UE and reporting the measurements to DU1, DU1 may decide on the measurement resources for the serving cell and the measurement reporting configuration based on information about the target cell resources for making L1/L2 mobility measurements in the target cell operated by DU2. DU1 may align/re-order the resources for making L1/2 mobility measurements in the serving cell and/or resources for reporting L1/2 mobility measurements via the serving cell depending on the information received from CU1 about target cell resources for making measurements in the target cell. For example, DU1 may align measurement type and align measurement resources with the aim of reducing battery consumption at UE. For example, serving DU1 may schedule L1/2 mobility measurement resources in the same time windows/frequency resources as those for the target cell operated by DU2.

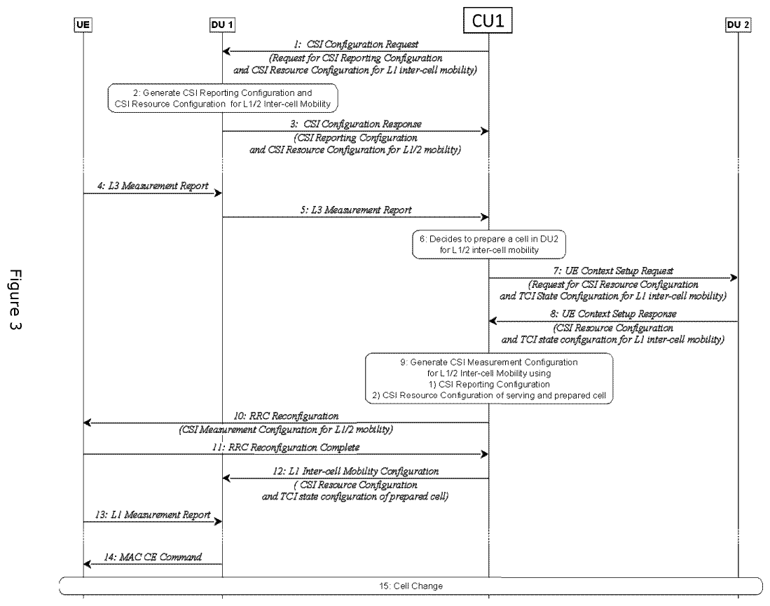

FIG. 3 illustrates an example of operations at a user equipment and units of a radio access network of FIG. 1 according to another example embodiment. DU1 (DU operating the cell serving the UE) receives from CU1 a request (e.g. CSI Configuration Request message) for information about L1/2 mobility measurement reporting configuration in the serving cell, and information about serving cell resources for L1/2 inter-cell mobility measurements in the serving cell (OPERATION 1 of FIG. 3).

DU1 generates a message (e.g. CSI Configuration Response message) including the requested information (OPERATION 2 of FIG. 3), and sends the message to CU1 (OPERATION 3 of FIG. 3). UE sends a L3 measurement report to CU1 via the serving cell operated by DU1 (OPERATIONS 4 and 5 of FIG. 3). Based on the L3 measurement report, CU1 decides to prepare a cell operated by DU2 for a possible L1/2 inter-cell handover (OPERATION 6 of FIG. 3). CU1 sends to DU2 a request (e.g. UE Context Setup Request message) for information about target cell resources for making L1/2 inter-cell measurements in the target cell operated by DU2 (e.g. CSI Resource Configuration), and information about operation of the UE in the target cell in the event of a handover to the target cell (e.g. TCI state information for the target cell) (OPERATION 7 of FIG. 3). DU2 provides the requested information to CU1 (e.g. in a UE Context Setup Response message) (OPERATION 8 of FIG. 3). Based on the information received from DU1 and DU2, CU1 generates (OPERATION 9 of FIG. 3) an information element (e.g. CSI Measurement Configuration) including: information about making L1/2 cell measurements in the serving and target cells; information about reporting the measurement results to DU1 via the serving cell, for use by DU1 in deciding whether to command UE to change to the target cell; and information about operation of UE in the target cell in the event of a L1/L2 handover to the target cell.

FIG. 11 shows a representation of an example information element. CU1 sends the information element to UE (e.g. as part of a L3 RRC Reconfiguration message) via DU1 and the serving cell (OPERATION 10 of FIG. 3). UE adopts the new configuration indicated by the received information element, and informs CU1 of completion of the reconfiguration (e.g. by a RRC Reconfiguration Complete message to CU1) via the serving cell and DU1 (OPERATION 11 of FIG. 3). CU1 also provides DU1 (e.g. by a L1 Inter-cell Mobility Configuration message) (OPERATION 12 of FIG. 3) with the information received from DU2 about the resources for L1/2 mobility measurements in the target cell, and the information received from DU2 about operation of UE in the target cell in the event of a L1/2 handover to the target cell. UE makes L1/2 mobility measurements according to the configuration indicated by the information element, and sends a L1 measurement report including the measurement results to DU1 (OPERATION 13 of FIG. 3). Based on the measurement results, DU1 may decide to send (OPERATION 14 of FIG. 3) a L1/2 command (e.g. MAC (Medium Access Control) CE (Control Element) command) to UE to change to the target cell (OPERATION 15 of FIG. 3).

According to one example variant of FIG. 3, operations 1, 2 and 3 of FIG. 3 are performed after operation 6 in parallel to operations 7 and 8.

According to one example variant of FIG. 3, operation 12 may be performed before or in parallel to operation 10.

The operations described above may be conditional on UE having provided to the NG-RAN a UE capability indicator indicating capability for L1/L2 inter-cell mobility.

In the example shown in FIG. 3, non-serving DU2 provides the L1/2 inter-cell mobility information as part of UE associated signaling. Non-serving DU2 includes the L1/2 inter-cell mobility information during the preparation of the UE context at the candidate target cell (e.g. in a UE Context Setup Response message to DU2).

According to another example, DU2 may provide L1/2 mobility information to CU1 using an F1 interface procedure used in the event that no target cell is prepared.

According to another example, non-serving DU2 provides the L1/2 mobility information to CU1 as part of non-UE associated signaling (i.e. before CU1 receives the L3 measurement report for UE). For example, non-serving DU2 may include the L1/2 mobility information in a message (such as e.g. a F1 Setup Request message of the kind described at 3GPP TS 38.473, section 8.2.3.2, or a gNB-DU Configuration Update message of the kind described at TS 38.473, section 8.2.4.2) during the setup of the F1 interface (between CU1 and DU2) or as part of a DU configuration update procedure for DU2. One or more common sets of L1/2 mobility information may be applicable for UEs capable of L1/L2 mobility. A plurality of common sets of L1/2 mobility information may be mapped to respective levels of UE capability. CU1 may choose one of the common sets of L1/2 mobility for a UE according to the capability of the UE.

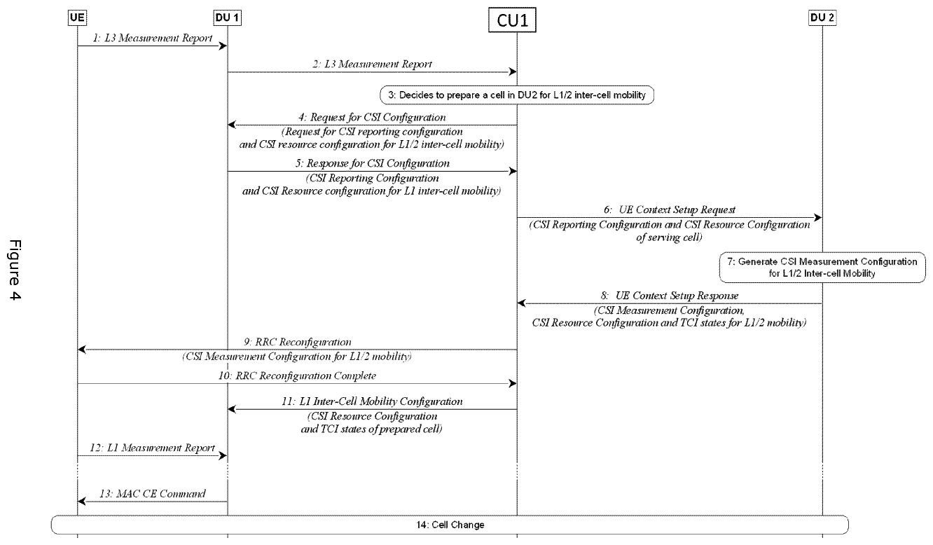

FIG. 4 shows a representation of an example of operations at UE and units of a RAN of FIG. 1 according to another example embodiment.

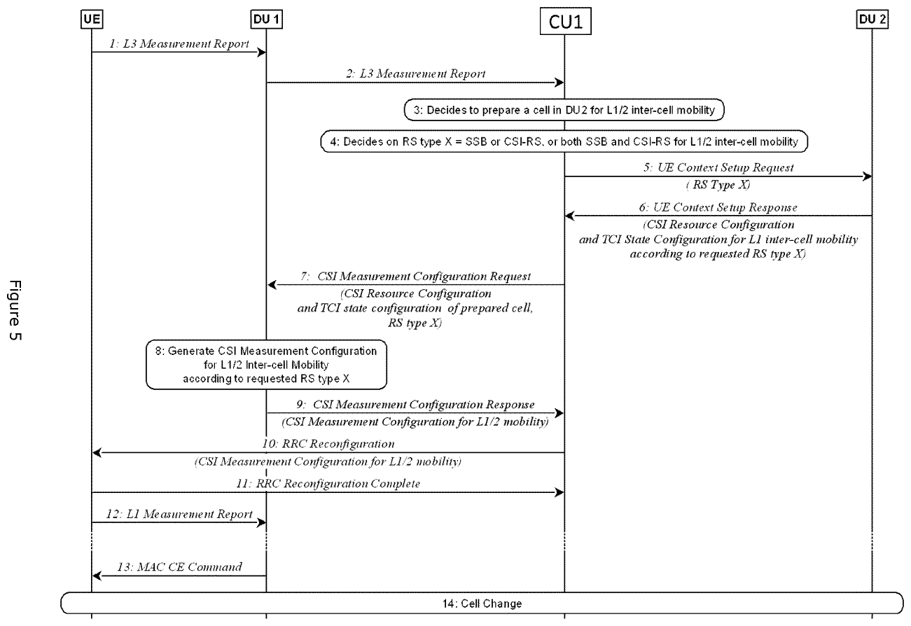

UE sends a L3 measurement report to CU1 via serving cell and DU1 (OPERATIONS 1 and 2 of FIG. 4). Based on the L3 measurement report, CU1 identifies a cell operated by another DU (DU2) as a target cell for L1/2 inter-cell mobility for UE (OPERATION 3 of FIG. 4). CU1 sends to DU1 a request (e.g. CSI Configuration Request message) for information (e.g. CSI Resource Configuration for L1 inter-cell mobility) about serving cell resources for L1/2 mobility measurements in the serving cell, and information (e.g. CSI Reporting Configuration) about reporting L1/2 mobility measurement results via the serving cell (OPERATION 4 of FIG. 4). DU1 provides the requested information to CU1 (e.g. via a CSI Configuration Response message) (OPERATION 5 of FIG. 4). CU1 sends the information received from DU1 to DU2 operating the target cell (e.g. in a UE Context Setup Request message) (OPERATION 6 of FIG. 4). DU2 generates an information element (e.g. CSI Measurement Configuration) for sending to UE (OPERATION 7 of FIG. 4). FIG. 11 shows a representation of an example information element. The information element comprises: the information received from DU1 via CU1; information (e.g. CSI Resource Configuration) about target cell resources for making L1/2 mobility measurements in the target cell; and information about operating in the target cell in the event of a L1/2 handover of UE to the target cell (e.g. TCI state information for the target cell). DU2 sends the information element to CU1 (e.g. in a UE Context Setup Response message) (OPERATION 8 of FIG. 4). CU1 sends the information element to UE via DU1 and the serving cell (e.g. in a L3 RRC Reconfiguration message) (OPERATION 9 of FIG. 4). UE adopts the new configuration indicated by the received information element, and informs CU1 of completion of the reconfiguration (e.g. via a L3 RRC Configuration Complete message to CU1) via the serving cell and DU1 (OPERATION 10 of FIG. 4). CU1 sends to DU1 (e.g. in a L1 Inter-cell Mobility Configuration message) information about the L1/2 mobility measurement resources (e.g. CSI Resource Configuration) in the target cell and information (e.g. TCI state information) about operation in the target cell in the event of a L1/2 handover of UE to the target cell (OPERATION 11 of FIG. 4). UE makes L1 measurements for the serving and target cells according to the configuration indicated by the received information element, and reports the measurement results to DU1 according to the reporting configuration indicated in the received information element (OPERATION 12 of FIG. 4). Based on the L1 measurement report received from UE, DU1 may decide to send (OPERATION 13 of FIG. 4) to UE a L1/2 command (e.g. MAC CE command) to change to the target cell (OPERATION 14 of FIG. 5).

In the example shown in FIG. 4, serving DU1 provides the L1/L2 mobility information to CU1 as part of UE associated signaling.

According to another example, serving DU1 provides the L1/L2 mobility information to CU1 as part of non-UE associated signaling (i.e. before CU1 receives the L3 measurement report for UE). For example, serving DU1 may include the L1/L2 mobility information in a message (such as e.g. a F1 Setup Request message of the kind described at 3GPP TS 38.473, section 8.2.3.2, or a gNB-DU Configuration Update message of the kind described at TS 38.473, section 8.2.4.2) during the setup of F1 interface between CU1 and DU1, or as part of a DU configuration update procedure for DU1. One or more common sets of L1/2 mobility information may be applicable for UEs configured with L1/L2 mobility. A plurality of common sets of L1/2 mobility information may be mapped to respective levels of UE capability. CU1 may choose one of the common sets of L1/2 mobility information according to information at CU1 about the capability of the UE.

In all of the example embodiments described above; a combination of UE-associated signalling and non-UE associated signalling may be used. Depending on one or more conditions, CU1 may decide (for a specific target cell for a specific UE) to use L1/2 mobility information etc. already received via non-UE associated signalling, or CU1 may decide to instead use UE-associated signalling. For example, if the load of the serving DU1 is high, CU1 may decide to use UE-associated signalling for L1/2 inter-cell mobility related configuration and preparation.

FIG. 5 shows a representation of an example of operations at UE and NG-RAN units according to another example embodiment. The example of FIG. 5 is the same as the example of FIG. 2 except for the following. CU1 makes a decision (OPERATION 4 of FIG. 5) about what one or more types of reference signals (e.g. SSB (Synchronisation Signal Block) or CSI-RS or both SSB and CSI-RS) to use for L1/2 mobility measurements in both the serving and target cells, and indicates the result of the decision about reference signal types in the request (e.g. UE Context Setup Request message) to DU2 for L1/2 mobility information for the target cell (OPERATION 5 of FIG. 5). CU1 indicates to DU2 the RS type(s) for which DU2 shall provide information about target cell measurement resources and information about operating in the target cell in the event of a L1/L2 handover of UE to the target cell. DU2 provides CU1 with the requested L1/2 mobility information for the RS type(s) indicated by CU1 (e.g. in the UE Context Setup Response message sent to CU) (OPERATION 6 of FIG. 5). CU1 also informs DU1 about the result of the decision about reference signal types (e.g. by an indication in the CSI Measurement Configuration Request message) (OPERATION 7 of FIG. 5). CU1 indicates to serving DU1 the RS type(s) for which DU1 shall include in the information element information about L1/2 mobility measurement resources in the serving cell and information about reporting L1/2 mobility measurements via the serving cell. The serving cell L1/2 mobility information included by DU1 in the information element (e.g. CSI Measurement Configuration) for sending to UE is L1/2 mobility information for the type(s) of reference signals indicated by CU1 (OPERATION 8 of FIG. 5).

FIG. 6 shows a representation of an example of operations at UE and NG-RAN units according to another example embodiment. The example of FIG. 6 is the same as the example of FIG. 3 except for the following. Serving DU1 makes a decision (OPERATION 2 of FIG. 6) about what one or more types of reference signals (e.g. SSB or CSI-RS or both SSB and CSI-RS) to use for L1/2 mobility measurements in both the serving and target cell(s). DU1 indicates (e.g. in the CSI Configuration Response message) (OPERATION 4 of FIG. 6) to CU1 the RS type(s) for which CU1 shall retrieve L1/2 mobility information from DU2. CU1 indicates to DU2 (e.g. in the UE Context Setup Request message sent to DU2) (OPERATION 8 of FIG. 6) the RS type(s) for which DU2 is to provide CU1 with L1/2 mobility information. DU2 provides CU1 (e.g. in the UE Context Setup Response message sent to CU1) (OPERATION 9 of FIG. 6) with L1/2 mobility information for the RS type(s) indicated by the CU1.

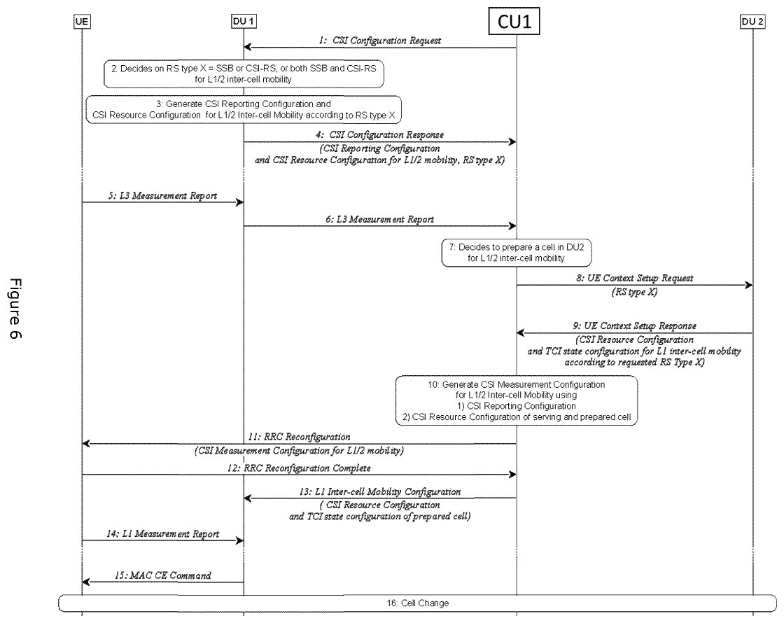

FIG. 7 shows a representation of an example of operations at UE and RAN units according to another example embodiment. The example of FIG. 7 is the same as the example of FIG. 4 except as follows. CU1 makes a decision (OPERATION 4 of FIG. 7) about what one or more RS types (e.g. SSB or CSI-RS or both SSB and CSI-RS) to use for L1/2 mobility measurements in both the serving and target cells. CU1 indicates to serving DU1 (e.g. in the Request for CSI Configuration message to DU1) (OPERATION 5 of FIG. 7) the RS-type for which DU1 is to provide L1/2 mobility information for the serving cell. DU1 provides CU1 (e.g. in the Response for CSI Configuration message sent to CU) (OPERATION 6 of FIG. 7) with L1/2 mobility information for the RS type(s) indicated by CU1. CU1 also indicates to non-serving DU2 (e.g. by an indication in the UE Context Setup Request message) the RS type(s) for which DU2 is to include L1/2 mobility information in the information element (e.g. CSI Measurement Configuration) to be generated at DU2 for sending to UE. The target cell L1/2 mobility measurement resource information included by DU2 in the information element (e.g. CSI Measurement Configuration) (OPERATION 8 of FIG. 7) for sending to UE is measurement resource information for the RS type(s) indicated by CU1.

In the example embodiments described above, DU1 and DU2 are associated with the same CU (CU1). However, the same kind of techniques are also applicable when the target cell is operated by a DU associated with another CU (e.g. DU3 associated with CU2 in FIG. 1). Signalling between DU3 and CU1 is done via (i) the Xn interface between CU1 and CU2, and (ii) the F1 interface between DU3 and CU2. Messages between DU3 and CU1 can be relayed via CU2 using a container transparent to CU2, or in an information element carrying the message content.

In the example embodiments describe above, a TCI state for a cell defines the Quasi Co-Location (QCL) information for receiving the PDCCH (Physical Downlink Control Channel) or PDSCH (Physical Downlink Shared Channel) signal of the cell. TCI state indicates to a UE the RS (reference signal) index (SSB index or CSI-RS index) based on which the channel information(s) (doppler shift, doppler spread, average delay, delay spread, spatial RX parameter) apply for receiving PDCCH or PDSCH of the cell. The configuration of TC states is described, for example, at TS 3GPP 38.331.

Regarding all of the examples of FIGS. 5 to 7: in the event that more than one RS type (e.g. both SSB and CSI-RS) is selected, the information element (e.g. CSI Measurement Configuration) sent to UE includes L1/2 mobility information for each RS type.

In the event that one RS type (e.g. CSI-RS) is selected, and e.g. DU2 cannot provide L1/2 mobility information for the selected RS-type (e.g. because normal operation of the target cell operated by DU2 does not involve the selected RS-type), the fallback position may be that DU2 instead includes L1/2 mobility information for the RS type (e.g. SSB) that is part of the normal operation of the target cell. In such an event, UE is configured to also make and report mobility measurements for at least one RS type (e.g. SSB) common to the operation of both serving and target cells, in order to optimise a comparison of the serving and target cells at DU1 for deciding on cell change.

The above-described techniques facilitate L1/L2 handover between cells operated by different gNB-DUs. The above-described techniques facilitate the initiation at a serving cell DU of the transmission of a MAC CE or L1 message for switching the UE from one TCI state to another TCI state for another cell operated by another gNB-DU.

The above-described techniques facilitate a decision at the serving cell DU about whether to change the UE from the serving cell to a target cell.

The above-described co-ordination of L1/L2 mobility information for one cell with the L1/L2 mobility information for another cell can better avoid a risk of an inaccurate L1/L2 mobility decision at the serving gNB-DU.

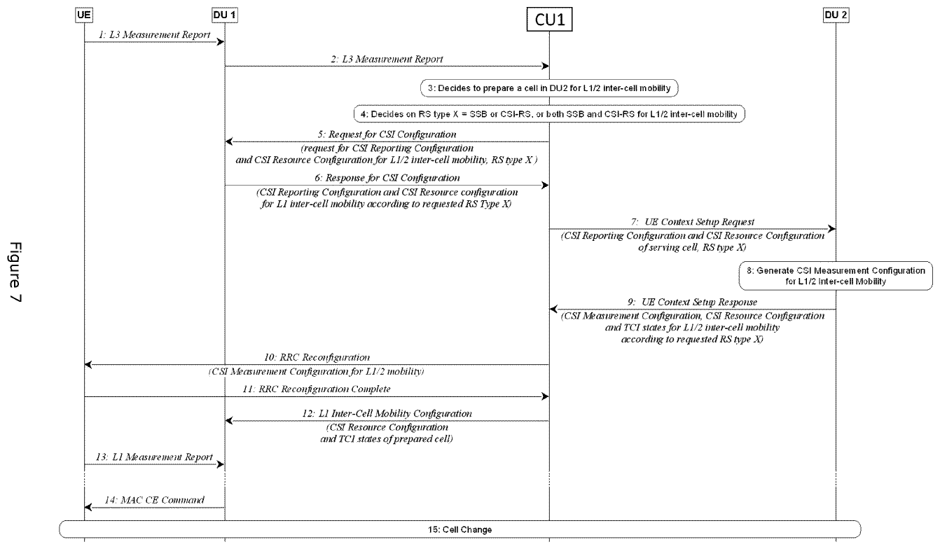

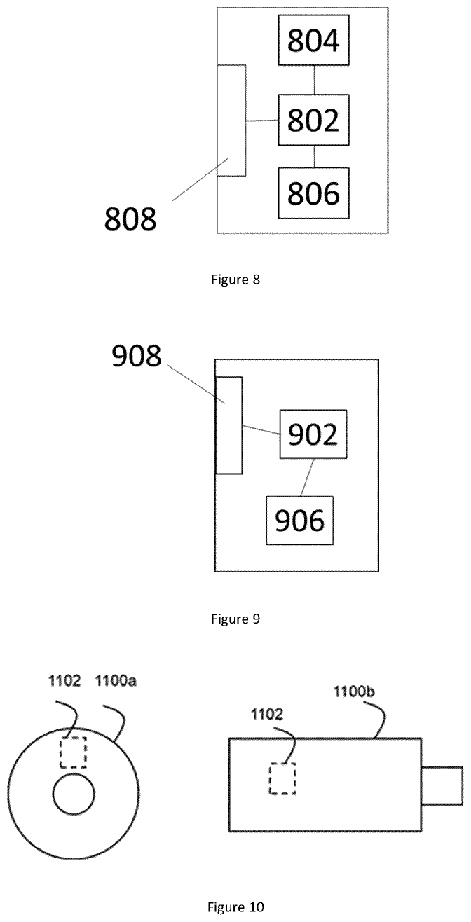

FIG. 8 illustrates an example of an apparatus for implementing UE functionality or gNB-RU functionality in FIG. 1. The apparatus may include at least one processor 802 coupled to one or more interfaces 808. For UE apparatus, the one or more interfaces 808 may include one or more interfaces to e.g. other equipment/component(s) for which the UE functionality provides radio communications. For gNB-RU apparatus, the one or more interfaces 808 may include an interface to the gNB-DU associated with the gNB-RU. The at least one processor 802 is also coupled to a radio unit 804 including one or more antennas etc. for making and receiving radio transmissions. The at least one processor 802 may also be coupled to at least one memory 806. The at least one processor 802 may be configured to execute an appropriate software code to perform the operations described above. The software code may be stored in the memory 806.

FIG. 9 illustrates an example of an apparatus for implementing gNB-DU functionality or gNB-CU functionality in FIG. 1. The apparatus may include at least one processor 902 coupled to one or more interfaces 908. For gNB-DU apparatus, the one or more interfaces 908 may include interfaces for communication with gNB-RUs associated with the gNB-DU, and an interface for communication with the gNB-CU associated with the gNB-DU. For the gNB-CU apparatus, the one or more interfaces 908 may include interfaces for communication with the gNB-DUs associated with the gNB-CU, and interfaces for communication with 5GC functions, such as UPF and AMF. The at least one processor 902 may also be coupled to at least one memory 906. The at least one processor 902 may be configured to execute an appropriate software code to perform the operations described above. The software code may be stored in the memory 906.

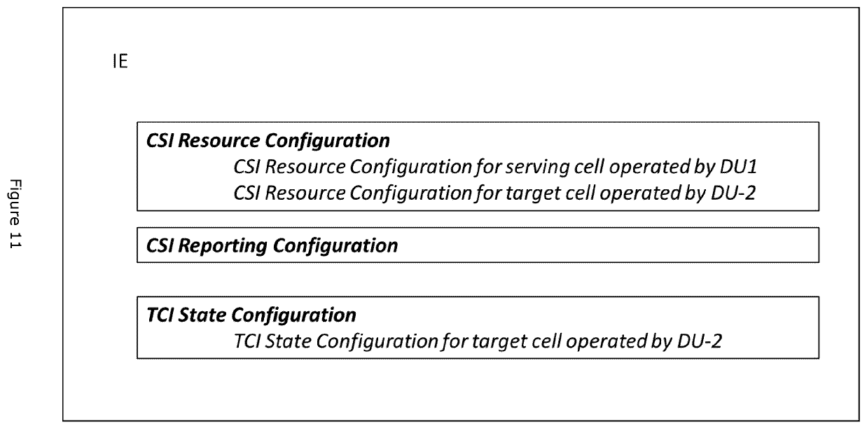

FIG. 10 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described example embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The features, advantages, and characteristics described herein can be combined in any suitable manner in one or more example embodiments. One skilled in the relevant art will recognize that such example embodiments can be practiced without one or more of the specific features or advantages of a particular embodiment. In other instances, additional features and advantages can be recognized in certain embodiments that may not be present in all example embodiments. One having ordinary skill in the art will readily understand that the example embodiments as discussed above may be practiced with steps in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-74. (canceled)

75. An apparatus comprising: at least one processor; and at least one memory including computer program code, the at least one memory and computer program code configured to, with the at least one processor, cause the apparatus to perform:
generating an information set for a user equipment;
wherein the information set includes at least a first channel state information (CSI) measurement configuration for configuring the user equipment to perform measurements for a mobility decision at a first distributed unit operating a first, serving cell of a radio access network;
wherein the measurements comprise at least:
a CSI measurement for the first, serving cell, and a CSI measurement for a second cell operated by a second distributed unit of the radio access network, the second cell being a candidate target cell for the mobility decision; and
transmitting the information set toward the user equipment.

76. The apparatus of claim 75, wherein the information set further comprises a first CSI reporting configuration for configuring the user equipment to report results of the measurements via the first, serving cell, for making the mobility decision at the first distributed unit.

77. The apparatus of claim 75, wherein the information set further comprises information for configuring the user equipment for operation in the second cell in the event of a decision at the first distributed unit to command the user equipment to perform serving cell change to the second cell.

78. The apparatus of claim 75, wherein generating the information set is based at least partly on information received via signalling associated with the user equipment.

79. The apparatus of claim 75:
wherein generating the information set is performed at the first distributed unit; and
wherein the at least one memory and computer program code are configured to, with the at least one processor, cause the apparatus to perform:
receiving at the first distributed unit at least second cell CSI resource configuration information regarding CSI resources for the second cell; and
sending the generated information set to a central unit associated with the first distributed unit, for forwarding by the central unit to the user equipment.

80. The apparatus of claim 79:
wherein the at least one memory and computer program code are configured to, with the at least one processor, cause the apparatus to perform:
receiving at the first distributed unit an indicator of a type of reference signal transmission for the measurement resources for the second cell.

81. The apparatus of claim 75:
wherein generating the information set is performed at a central unit associated with the first distributed unit; and
wherein the at least one memory and computer program code are configured to, with the at least one processor, cause the apparatus to perform:
receiving at the central unit at least: second cell measurement resource information regarding measurement resources for the second cell; first cell measurement resource information regarding measurement resources for the first, serving cell; and measurement reporting information about reporting measurement results to the first distributed unit via the first cell; and
sending the generated information set to the user equipment.

82. The apparatus of claim 81:
wherein operation of the first, serving cell comprises making at least two types of reference signal transmissions, and
wherein the at least one memory and computer program code are configured to, with the at least one processor, cause the apparatus to perform:
receiving at the central unit an indicator of the type of reference signal transmission for the measurement resources for the first, serving cell; and
sending to the second distributed unit a request for information about measurement resources for the same type of reference signal transmission in the second cell.

83. The apparatus of claim 82, wherein the at least one memory and computer program code are configured to, with the at least one processor, cause the apparatus to perform:
receiving at the central unit: information about measurement resources for the same type of reference signal transmission in the second cell, in the event that operation of the second cell comprises making the same type of reference signal transmission; or information about measurement resources for another type of reference signal transmission in the second cell, in the event that operation of the second cell does not comprise making the same type of reference signal transmission; and
sending to the first distributed unit an indication of the type of reference signal transmission for which information about measurement resources was received from the second distributed unit.

84. The apparatus of claim 75:
wherein generating the information set is performed at the second distributed unit; and
wherein the at least one memory and computer program code are configured to, with the at least one processor, cause the apparatus to perform:
receiving at the second distributed unit at least: first cell measurement resource information regarding measurement resources for the first, serving cell; and measurement reporting information about reporting measurement results to the first distributed unit via the first, serving cell; and
sending the generated information set to a central unit associated with the first distributed unit, for forwarding by the central unit to the user equipment.

85. The apparatus of claim 84, wherein the at least one memory and computer program code are configured to, with the at least one processor, cause the apparatus to perform: sending, to the central unit for forwarding to the first distributed unit, at least one of the second cell measurement resource information regarding measurement resources for the second cell and information regarding transmission configuration indicator states for the second cell.

86. The apparatus of claim 84:
wherein operation of the first, serving cell comprises making at least two types of reference signal transmissions, and
wherein the at least one memory and computer program code are configured to, with the at least one processor, cause the apparatus to perform:
receiving at the second distributed unit an indicator of the type of reference signal transmission for the measurement resources for the first, serving cell; and
including in the information set information about measurement resources for the same type of reference signal transmission in the second cell, in the event that operation of the second cell comprises making the same type of reference signal transmission; or
including in the information set information about measurement resources for another type of reference signal in the second cell, in the event that operation of the second cell does not comprise making the same type of reference signal transmission.

87. The apparatus of claim 75, wherein the at least one memory and computer program code are configured to, with the at least one processor, cause the apparatus to perform:
after determining that the user equipment has performed a serving cell change to the second cell, transmitting to the user equipment a second CSI measurement configuration for configuring the user equipment to perform a measurement for a second mobility decision toward the first cell.

88. The method of claim 87, wherein the at least one memory and computer program code are configured to, with the at least one processor, cause the apparatus to perform:
after determining that the user equipment has performed a serving cell change to the second cell, transmitting to the user equipment a second CSI resource configuration for reporting a result of the measurement toward the first, serving cell for the second mobility decision.

89. A user equipment comprising: at least one processor; and at least one memory including computer program code, the at least one memory and computer program code configured to, with the at least one processor, cause the apparatus to perform:
receiving an information set via a first, serving cell operated by a first distributed unit of a radio access network;
wherein the information set at least includes a first channel state information (CSI) measurement configuration for configuring the user equipment to perform measurements for a mobility decision at the first distributed unit;
wherein the measurements comprise at least:
a CSI measurement for the first, serving cell, and a CSI measurement for a second cell operated by a second distributed unit of the radio access network, the second cell being a candidate target cell for the mobility decision;
performing measurements for at least the first and second cells according to the information set; and
reporting results of the measurements to the first distributed unit via the serving cell, for the mobility decision at the first distributed unit.

90. The user equipment of claim 89, wherein the information set further comprises a first CSI reporting configuration for configuring the user equipment to report results of the measurements via the first, serving cell, for making the mobility decision at the first distributed unit;
wherein reporting the results of the measurements comprises transmitting the results of the measurements using a resource indicated by the first CSI reporting configuration.

91. The user equipment of 89, wherein the at least one memory and computer program code are configured to, with the at least one processor, cause the apparatus to perform:
after the user equipment performs a serving cell change to the second cell, receiving a CSI measurement configuration for configuring the user equipment to perform a measurement for a second mobility decision toward the first, serving cell.

92. The user equipment of claim 91, wherein the at least one memory and computer program code are configured to, with the at least one processor, cause the apparatus to further perform:
after the user equipment performs a serving cell change to the second cell, receiving a second CSI resource configuration for reporting a result of the measurement for the second mobility decision; and
wherein reporting the results of the measurements comprises transmitting the results of the measurements for the second mobility decision using a resource indicated by the second CSI resource configuration.
